(19) United States
(12) Patent Application Publication
(10) Pub. No.: US 2003/0128136 A1
(43) Pub. Date: Jul. 10, 2003

(54) Electronic parking meter having audio-video communications with a central station

(75) Inventors: Ira Jay Spier, Bronxville, NY (US); John Patrick Larson, Bronxville, NY (US)

Correspondence Address: NOTARO AND MICHALOS, 100 DUTCH HILL ROAD, SUITE 110, ORANGEBURG, NY, 10962-2100, US

(73) Assignee: MACROPARK, INC.

(21) Appl. No.: 10/040,571

(22) Filed: Jan. 7, 2002

(51) Int. Cl. G08G 1/14

(52) U.S. Cl. 340/932.2; 705/13

(57) ABSTRACT

A terminal of a parking meter system includes two-way audio and visual communications with a central administration station for assisting customers using the terminal. The terminal has coin and bill acceptors in communication with a computer for managing the terminal operation. A video display in the terminal can alternately display payment information or a camera view of a central station operator when communication is initiated. Two-way communication between the terminal and central station provides immediate trouble-shooting and resolution of customer complaints such as lost bills or coins and failure to credit payment. Monitoring of the terminal by a central station operator provides prompting for service for coin and bill collection and/or impounding illegally parked vehicles, among other attendant functions, so that an attendant is only present as needed.

### FIELD AND BACKGROUND OF THE INVENTION

The present invention relates generally to the field of electronic parking meter systems and in particular to an electronic parking meter system having a two-way audio and video communications between the electronic parking meter system and a central station.

Parking meters providing unattended sale of space usage or parking time for multiple parking spaces are well known and widely used in street and off-street parking lots for vehicles. These parking meters include display panels for designating the space being used and identifying required payments to deposit in the meter. The timing interval, or the amount of time vended by the meter to the customer, is typically determined by the amount of money which is inserted into the parking meter.

Parking meters for multiple parking spaces include simple mechanical devices in the form of a box having a plurality of numbered slots corresponding to the numbered parking spaces in the lot. The customer parks in an available parking space. He then proceeds to the parking meter box and deposits money in the numbered slot corresponding to his parking space. Since lots with these meter boxes are often unattended, if the wrong slot is accidentally used, the customer must either insert more money into the correct slot or risk the owner of the parking lot taking action for failure to pay.

More complex electronic parking meters have replaced mechanical-based meters in some cases. Although electronic parking meters often have mechanical parts, the primary thrust of modern parking meter technology is directed to solid state circuitry and apparatus for parking meters which minimizes downtime, reduces mechanical unreliability, and provides an electronic means of accounting. An advantage of modern electronic parking meters is that they may be triggered externally without the use of coins. Accordingly, payment slots may be included for the use of credit cards or debit cards.

Electronic parking meters include both single space meters and parking lot terminals. For a contained area, a terminal can be more efficient, like the mechanical terminal box, because a single device is used to collect fees for each parking space in a lot, as opposed to having individual meters for each spot, like on-street parking.

An electronic parking meter terminal is disclosed in U.S. Pat. No. 4,379,334. This type of terminal is capable of covering a plurality of parking spaces with a single parking meter These meters generally include a clock, a coin and/or bill acceptor, electronic processing circuits and a printer.

In some older electronic parking meters, the customer inserted money into the parking meter, received a receipt upon which an expiration time appears from the meter, and then had to return to their vehicle to place the receipt in the windshield of the vehicle.

In newer electronic-based parking systems, however, the customer keys in a code identifying the parking space in which the vehicle has been parked, such as a numeric designation, or, in some cases, the vehicle's license plate number. The customer then deposits money into the meter using coins, bills or sometimes, using a credit card. The meter stores the expiration time (based on the amount paid) in its memory correlated to the parking space or license plate number permitting the customer to proceed without having to place the receipt in a clearly visible position in the vehicle.

Parking meters having data communications with a central location are known. Generally, these meters are used to relay information to a central location, such as an expired meter status, but do not permit communications back to the meter.

For example, a single space parking meter having a radio frequency transmitter for communicating the status, i.e., meter malfunction, expiration of time, to a central location is disclosed in U.S. Pat. No. 5,454,461.

U.S. Pat. No. 6,230,868 discloses a multiple parking space meter terminal having a peripheral port for sending and receiving computer data from a central location by wireless or by a cable connection. The data connection does not support voice and video communication between a customer and a person at the central station.

A multi-bay parking meter mounted on a supporting stanchion and programmed to permit the control of four separate parking spaces is disclosed by U.S. Pat. No. 5,617,942. The standard display window for the meter is used to advise the user of the status of the respective spaces. The meter detects whether a car is present in the spaces and determines the meter status.

A multiple space parking meter terminal sold under the name MITIVEND by MITI Manufacting Co. includes an automated communications link to emergency services, such as fire, police or to a parking attendant to alert of emergency situations. However, the MITIVEND meter terminal does not include two way communications for a person using the terminal to communicate with a remote parking attendant or emergency services personnel. The MITIVEND meter does not provide video communications on a terminal display.

While known parking meter terminals are useful for their intended purposes, none provides for customer service or assistance communications with an administrative station for resolving customer problems with the meter terminals. Parking fees are increasingly expensive in larger metropolitan areas where such terminals are most useful, and the costs associated with parking without paying properly are equally high. Therefore, a meter terminal which includes customer service functions is needed to assist customers who have difficulty with the terminal to avoid additional costs to customers for incorrect payments or inability to pay because of a meter malfunction.

### SUMMARY OF THE INVENTION

It is an object of the present invention to provide a parking meter terminal having a single display unit for assisting parking space payments at the terminal, and alternately used in a two-way audio-video link with a central administration station for the terminal.

Yet another object of the invention is to provide two-way communications between a parking meter terminal and a central station to provide customer service or assistance.

A further object of the invention is to provide a parking meter terminal system in which several parking lot meter terminals can be remotely administered by a single central station that provides customer assistance through the terminals.

Accordingly, a parking meter terminal is provided for recording meter fees for multiple spaces, such as in a parking lot, having audio-video communications with a central location or remote attendant. The parking meter terminal includes a computer with a memory, and audio/video inputs and outputs. The computer is connected to money acceptors. The computer is connected via wiring and/or wireless to a computer network for communication with a central administration station.

The parking meter terminal has a video display with a touch screen over it for entering a parking space number to advance pay the parking fee calculated by the computer based on a time selected by the user. The parking meter includes bill and coin acceptors for receiving the parking fee for the selected parking space, as well as a credit card or other payment card receiver. The parking meter contains an operating system for displaying instructions on the video display, receiving input from a person paying for a space, identifying a parking space, receiving money and allocating that money as payment for an identified parking space. The touch screen of the parking meter is a brightly lit display to assist persons using the meter seeing the commands on the touch screen.

The parking meter terminal further includes a two-way communications system between the meter and a central location or a remote attendant. A video camera, microphone and speaker are provided in the parking meter and all connected to the computer. The video display screen used to assist payment transactions is also used to show the central location or remote attendant, or instructional text and/or graphics from the remote attendant to a person at the meter terminal. The communications can run through a telephone line, a dedicated communications line or across the computer network. The communications can be activated in the event of a problem at the parking meter terminal for customer service.

The parking meter terminal is contained in a housing adapted to be located on the street or at the entrance of a parking lot for use in controlling parking at multiple spaces. The housing includes a mounting area for bill, coin and credit card acceptors and the display panel. The housing includes anti-theft mechanisms to avoid vandalism and theft of collected money or components of the terminal.

A lower housing section supports coin cans for use with a collection system and a coin return means is provided so that coins deposited at the wrong time, or invalid coins, will not be collected. The housing design is such that very high security is achieved since there are no areas where easy access to the lower housing can be obtained. The upper housing is designed for minimum susceptibility to vandalism. The combined upper and lower housing sections provide an aesthetically pleasing appearance, and since the need for a single stanchion for each parking space is eliminated, the overall street appearance is enhanced when the concepts of this invention are employed.

Since only a single meter mechanism is required for multiple spaces, the cost for parking enforcement is reduced. Furthermore, maintenance is simplified since the mechanism can be easily replaced whenever service is required so that the downtime for any particular group of parking spaces will be minimal. Collection of revenues is also simplified since the revenue from several spaces is obtained in a single collection operation.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a diagram of a system incorporating the parking meter terminal of the invention;

FIG. 2 is a front elevation view of a front panel of a parking meter terminal of the invention;

FIG. 3 is a rear elevation view of a front panel of the parking meter terminal of FIG. 2;

FIG. 4 is a side elevation view of the video display assembly of the parking meter terminal of FIG. 2; and

FIG. 5 is a schematic diagram of a computer controller for the parking meter terminal of FIG. 2.

### DESCRIPTION OF THE PREFERRED EMBODIMENTS

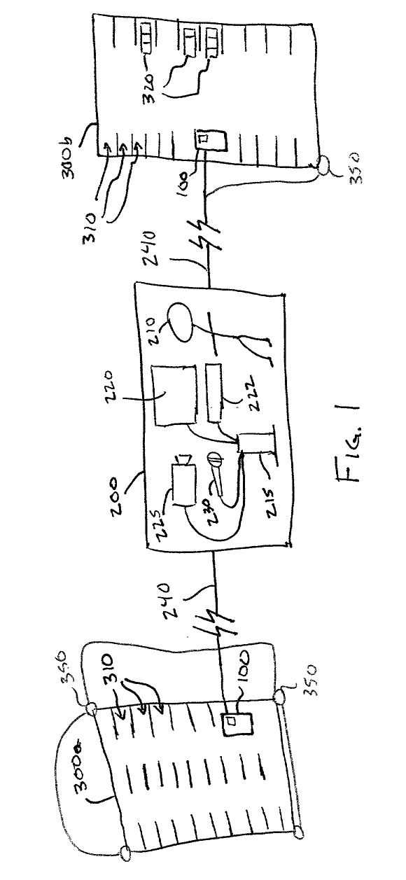

Referring now to the drawings, in which like reference numerals are used to refer to the same or similar elements, FIG. 1 illustrates a multiple parking lot system using parking meter terminals 100 according to the invention. The system in FIG. 1 shows two parking lots 300a, 300b, each having a plurality of parking spaces 310 which accommodate cars and trucks 320. A meter terminal 100 is provided at the exit to each lot 300a, 300b for customers parking their cars 320 to pay. Each space 310 in the lot can be identified by a unique alphanumeric, graphical or combination thereof designator. The unique designator for the space 310 that the customer wants to pay for parking time is entered into the terminal 100 and payment is made.

The system of FIG. 1 includes a connection 240 from each meter terminal 100 to a central administrative station 200. The connection 240 carries audio, video and data signals from the terminals 100 to a computer 215 at the central administrative station 200. A human operator 210 monitors the computer 215 using a video monitor 220 and input device 222, such as a keyboard, pointing device or pen. A microphone 230 and camera 225 are provided in the central administrative station 200 so that the operator 210 can communicate using two-way audio and video with customers at the terminals 100, as will be described below in greater detail.

The connection 240 can be a hardwired or wireless connection, or a combination of the two. The connection 240 can be made over dedicated lines, or using a commercial computer network system. The connection 240 may be by fiber optic cable, copper wire, radio frequency or other available transmission means.

The terminals 100 are each formed as a box containing the component parts of the meter system. The box forming the meter terminal 100 preferably has a front panel 10, a rear panel, top and bottom panels and two side panels. The parking meter terminals 100 may be mounted directly on the ground or supported on a post or stanchion 117. Even if a wireless connection 240 is used, the meter terminal 100 still requires power, so that a secure method of mounting the terminal to the ground where a power source can be provided is necessary.

The details of the meter terminal 100 will now be described further.

### Meter Housing

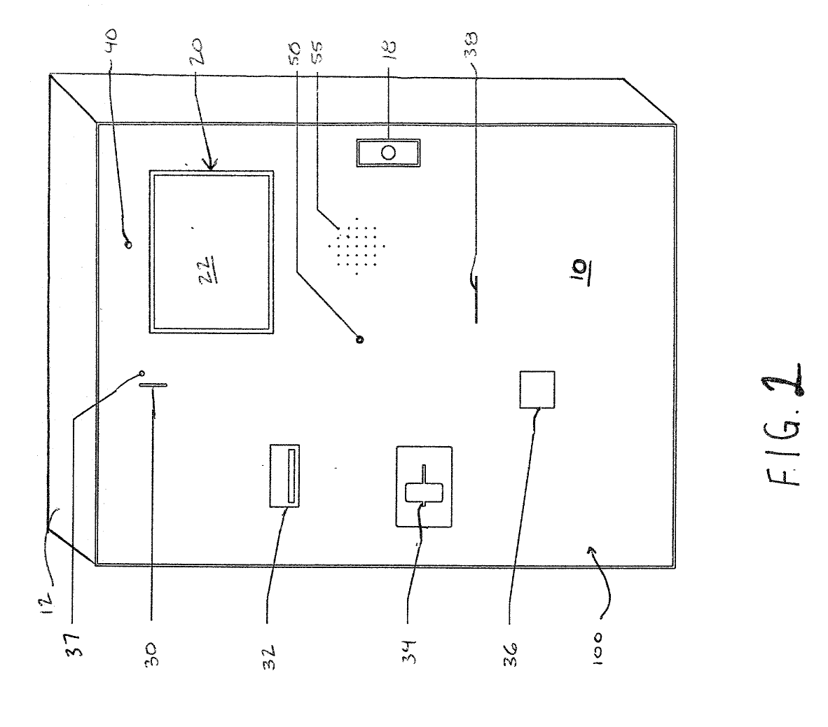

FIG. 2 illustrates a the front panel 10 of a housing box 12 forming the parking meter terminal 100. The housing box 12 is preferably made from 11-gauge steel with a double-wall aluminum insulation. The front panel 10 of the housing box 12 is hinged to provide access to the interior for service and money removal. A high-security lock 18 locks the front panel 10 to the rest of the housing box 12.

The front panel 10 of the housing box 12 includes several items accessible by a customer for entering their parking space identifier, paying for a set amount of parking time, acknowledging the purchased parking time, and, when necessary, communicating with the operator 210 at the central administrative station 200. The items include a touch-sensitive panel and display assembly 20, coin, bill and credit card acceptors 30, 32, 34 and coin return 36, and a camera 40, microphone 50 and speaker 55.

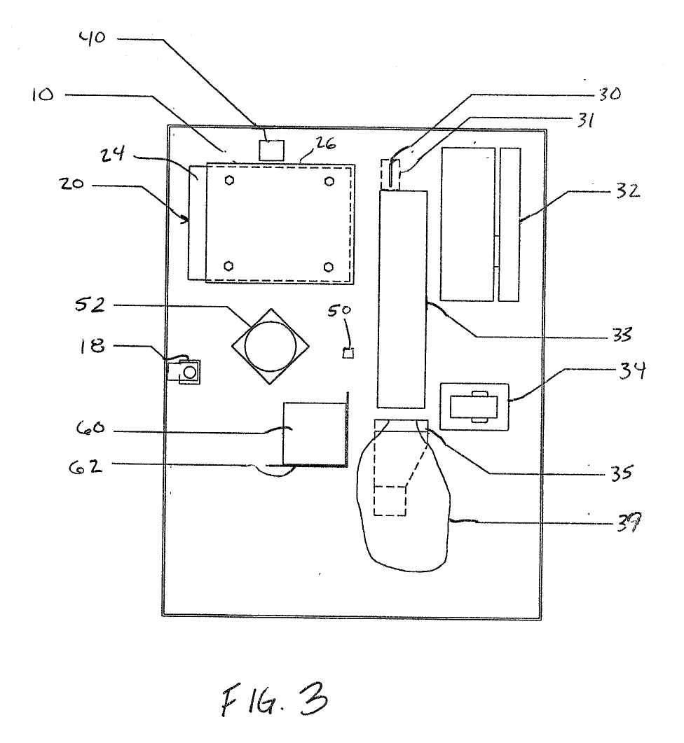

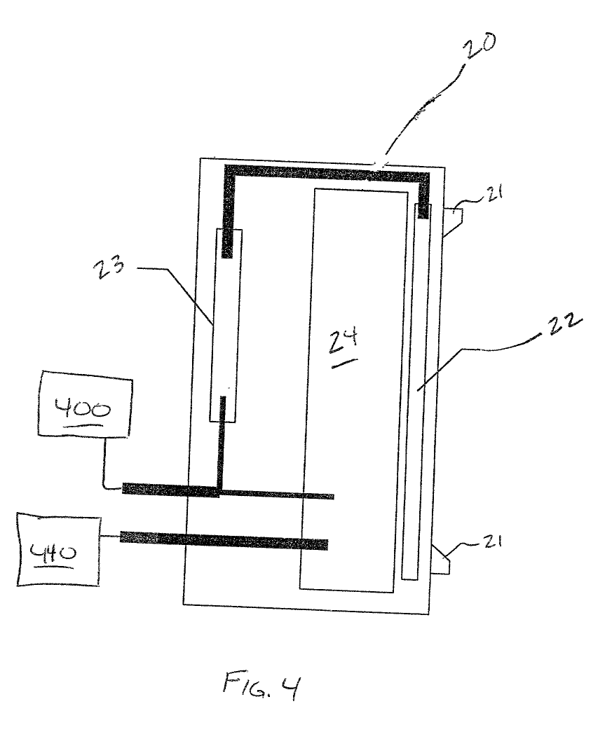

FIG. 3 shows the interior side of front panel 10 on which the functional devices mentioned above are mounted with their component parts. FIG. 4 illustrates a preferred construction for the display assembly 20.

The details of the functional devices and their component parts will now be described in greater detail with reference to FIGS. 2-4.

### Display Assembly

A touch screen panel and display assembly 20 are preferably located at the top right corner of the front panel 10 of the housing box 12. The touch screen panel 22 is transparent and overlies a display screen 24. The touch screen panel 22 of the display assembly 20 can be recessed from the front panel 10 surface, so that its edges are overlapped by the edges of an opening through the front panel 10. Alternatively, a secure frame can be mounted to the front panel 10 over the display assembly 20 to prevent it from being removed through the front panel 10.

Protective shields 21 can be provided to protect the touch screen panel from rain, snow and other physical damage.

As shown in FIG. 4, the display assembly 20 comprises a liquid crystal display (LCD) panel 24, such as the Planar® Model ColorBrite™ LC640.480.33-AC., the touch screen panel 22, such as a Dynapro™ brand touch screen, and a touch screen driver board 23. The touch screen driver board 23 and LCD display 24 are connected to power source 400; LCD display 24 is also connected to video driver board 440.

The LCD panel 24 provides visual feedback and instruction information to a customer using the electronic parking meter terminal 100. The LCD can display the status of each parking space, the time remaining for a selected space and/or a graphical map of the parking area to enable the user to determine which of the parking spaces are available or which space the user has occupied.

Preferably, the LCD panel 24 provides a very bright image to a customer, even in daylight. The Planar® LCD noted above is one such LCD panel 24. The LCD panel 24 preferably has an areal luminance of about 1,000 NITS or more and can be viewed in a 140° in front of the display. The LCD panel 24 is preferably sized to provide a good visibility picture, such as a 10 inch or greater screen size, although smaller LCD panels 24 may be used.

The touch screen panel 22 allows the customer to communicate with the visual information shown on the LCD panel. The user presses over graphic images shown on the LCD display 24 through the transparent touch screen panel 22 to input information into the electronic parking meter 100. The interface between the LCD panel 24 and the touch screen panel 22 and between the touch screen panel 22 and a user is well known in the art. As will be appreciated, the video driver board 23 connects the touch pad 22 to the video controller 440 in a computer of the terminal 100 through the LCD panel 24.

A key pad, such as a Digitran™ Model KL0042, or other input device (not shown) may be provided and mounted in the front panel 10 instead of a touch screen panel 22 for entering selected information into the electronic parking meter terminal 100.

### Payment System

A user of the electronic parking meter terminal 100 can pay for the parking space with coins, bills or a magnetic strip card, including a credit card, a debit card, a parking card or a driver's license.

The electronic parking meter terminal 100 includes a coin slot 30 through which coins are inserted. A coin insertion shroud 31 is provided on the rear of the front panel 10 to prevent coins from dropping loose into the housing box 12. A coin acceptor/sorter 33 receives coins inserted through the coin slot 30 directed by shroud 31. The acceptor/sorter 33 is of a known type, such as the Coinco™ Model Quantum 700198 , which determines the value of the received coins and ignores slugs.

The value of the coins deposited determines the parking time. The coin slot 30 may instead be a series of coin slots (not shown) for receiving nickels, dimes, quarters, dollar and other denomination coins based on their sizes.

Once the coin acceptor/sorter 33 checks the denomination of the coins inserted into the slot 30, coins pass through either a first coin path (not shown) to a coin box in the acceptor/sorter for storing acceptable coins, or through a second coin path 35 to coin return opening 36 located on the front panel 10 for returning unacceptable coins. A coin return lever 37 connected to the coin acceptor/sorter 33 is located on the front panel 10 for a customer to request their coins be returned. A coin overflow bag 39 is provided at the lower end of the acceptor/sorter 33 to receive excess coins that will not fit in the coin box until the terminal 100 can be serviced to remove the money.

A bill acceptor 32, such as a Coinco™ Model MAG50™, is located through the front panel 10 of the housing box 12. The bill acceptor 32 receives bills through a slot on the outside of the of the housing box 12. The slot is preferably located below the coin insertion opening 32.

A magnetic strip card reader 34 is also mounted through the front panel 10. The magnetic strip card reader 34 includes a card insertion opening that receives a magnetically encoded card, such as a credit card, debit card, parking card or driver's license. The card reader 34 is preferably located below the bill acceptor 40 on the front panel 10 of the housing box 12. The magnetic strip card reader 34 communicates with a card inserted into the opening to accept and interrogate the card, in a well known manner.

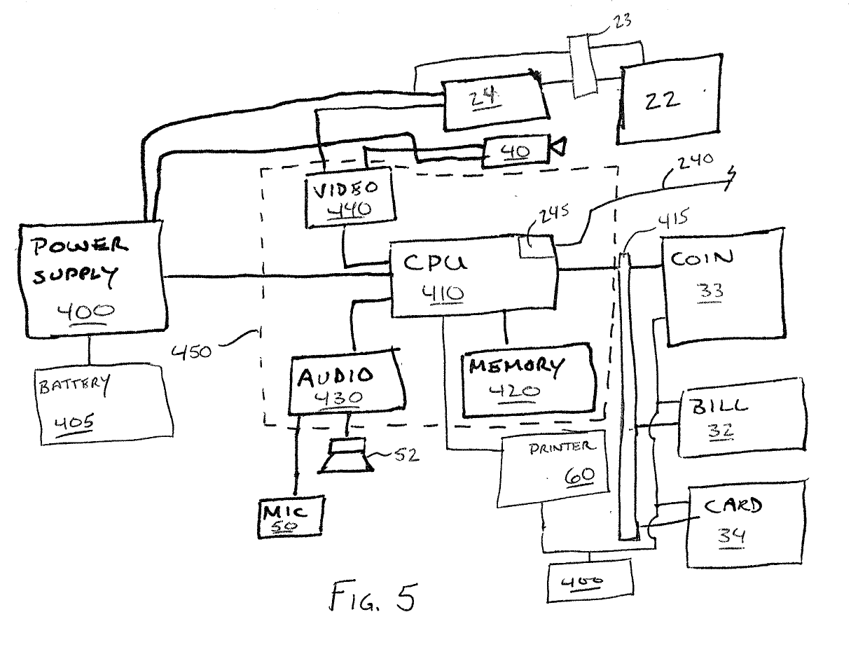

The coin acceptor 33, bill acceptor 32 and magnetic strip card reader 34 are all electrically connected to a computer 450 (shown in FIG. 5) inside the terminal 100 in a known manner, preferably by ribbon data cable (not shown). The computer 450 determines the time when paid-up parking expires based on the total amount of money inserted into the electronic parking meter terminal 100 by coin, bill and/or card, and the present time. The time can be calculated using a clock program or circuit, or received from the central administrative station 200.

### Audio System

The audio system of the meter terminal 100 provides audio feedback to a customer, as well as voice transmissions from the operator 210 at the central administrative station 200 for customer service.

A speaker 52 is mounted the inside of the front panel 10 behind speaker grille openings 55 through the front panel 10. The speaker 52 emits audio sounds generated by the computer 450 in the electronic parking meter terminal 100 in accordance with received signals in a known manner. The speaker 52 and speaker grille 55 are preferably positioned in close proximity adjacent the display assembly 20.

A microphone 50 mounted near the speaker 52 in the front panel 10 is provided for receiving speech from a customer or other sounds. The microphone is preferably positioned below the display assembly 20 and adjacent the speaker grill 61 so that it is in comfortable working relation with the user of the electronic parking meter 100. The microphone 70 is connected to the central processing assembly 100.

### Video System

A video camera 40 for recording real-time video of a customer using the meter terminal 100 is secured inside the housing box 12. The video camera 40 is oriented so that a space immediately in front of the front panel 10 is visible to the video camera 40 through an opening in the front panel 10. Preferably, the video camera 40 is positioned just above the display assembly 20.

The video camera 40 may be a pin-hole type camera, which has a small footprint and is more easily used in the meter terminal 100 because it requires less space. CCTV cameras, CCD type cameras or other digital and analog cameras can be used to receive real-time images for the meter terminal 100.

The camera 40 transmits the received images as an electronic signal in its known format to the computer 450 for processing and transmission to the central administrative station 200. The term “video” as used herein should be understood to include combined audio/video streams configured in accordance with standards such as H. 261, MPEG and MPEG II as well as streams which include video in combination with other types of data.

The video signal may be monitored or recorded at the central administrative station 200. The video signal is part of the two-way audio/video communication with a customer.

Video images that have been recorded may be played back from stored files if the operator 210 at the central administrative station 200 so desires. The video signal can be stored on any known media, such as a magnetic disk array or tape, a recordable optical disk or an electronic memory.

Preferably, however, the operator 210 views the video signal stream live as it is transmitted from electronic parking meter terminal 100 on the monitor 220. The camera 40 allows the central station operator 210 to see the customer having problems with the meter terminal 100 while providing customer assistance. Similarly, the central station camera 215 transmits a video signal from the station operator 210 to the LCD panel 24 of display assembly 20 so that the customer can see who they are talking to via the audio system. The central station operator 210 can also transmit instructions to the customer for display on the LCD panel 24 in place of or in combination with the central station camera 215 video signal.

In an alternative embodiment, the video signals from the camera 40 and central station camera 215 may be transmitted and received through a video server contained within the terminal housing box 12.

### Printer

A printer 60 is provided for generating customer receipts, such as an LRC Model 7000. The printer 60 is supported on a bracket 62 inside the housing box 12 on the inside of front panel 10. The printer 60 ejects receipts through a printer receipt slot 38 in the front panel 10. The printer 60 is preferably connected directly to the computer 450, which drives the output to the printer.

### Computer

Turning now to FIG. 5, a computer 450 of the meter terminal 100 includes a central processing unit (CPU) 410 with a memory 420, audio controller 430 and video controller 440. CPU 410 can include a network interface 245 for connecting to the central administrative station 200 through connection 240. Alternatively, the network interface with connection 240 may be separate from the CPU, such as a router or hub connector.

The CPU 410 is powered by a power supply 400 having a backup battery 405 in the event of a power loss at the meter terminal 100. The memory 420, and audio and video controllers 430, 440 all receive power through the CPU 410.

The memory 420, and audio and video controllers 430, 440 may all be separate components or they may be included on the same circuit as the CPU 410.

The CPU 410 is preferably a PC104 motherboard using an Intel 8086-based processor chip.

A multi-drop bus 415 connects the CPU 410 to each of the coin, bill and credit card acceptors 33, 32, 34. The CPU 410 manages the information received from each of the money acceptors 32, 33, 34 to determine when payment has been made, if the payment is valid and how much time to credit a particular parking space based on the payment.

The microphone 50 and speaker 52 are connected to the audio controller 430 for managing the received and transmitted signals. The microphone 50 and speaker 52 are powered through the audio controller 430.

As discussed above, camera 40 and LCD panel 24 are connected to the video controller board 440. Video controller board 440 handles video image processing for the CPU 410.

Audio and video controllers 430, 440 are preferably PC104 type compatible boards.

The backup battery 405 is preferably a rechargeable battery, so that its useful life is extended for protecting the meter terminal 100 from power outages.

Network interface 245 connects the computer 450 to the central station 200. The network interface 245 manages transmission and reception of audio, video and data signals in bi-directional communication across connection 240 with the central administrative station 200 for processing by CPU 410.

Printer 60 is connected to CPU 410 for receiving instructions for printing receipts for payment using the meter terminal 100.

CPU 410 has programming for operating the printer 60, coin, bill and card acceptors 33, 32, 34, audio and video controllers 430, 440. CPU 410 includes routines for recognizing an input from a customer requesting customer service in order to initialize the two-way communication with the central administrative station 200. The CPU 410 can also include self-diagnostic routines for the several connected components which initializes communication with the central station 200 when a problem is detected.

The parking meter terminal 100 thus provides a two-way communication with a central station 200 for providing customer service on demand or in response to a terminal 100 system problem.

Once two-way communication is established, the operator 210 at the central station 200 may provide customer assistance to a person using the terminal 100. The customer assistance may include verbal and video prompting instructions for using the terminal via the video and audio systems. Also, if a customer requires a refund, the operator 210 can determine if a refund is appropriate, and if the terminal 100 is not malfunctioning, provide the refund from the remote central station 200 location without having to have a lot attendant present.

Further, when used in combination with video surveillance of the parking spaces in the lot 300a, 300b using lot cameras 350 connected to the central station 200, the operator 210 can compare receipts at the parking meter terminal 100 with cars 320 parked in the lots 300a, 300b and determine if punitive action is required. For example, if a car 320 is parked without having paid for the space at the terminal 100, or the time paid for has expired, the operator 210 can direct an attendant to visit the lot and either tow the offending car, or place a tire boot on the car to prevent the owner from leaving without paying. In the case of immobilizing the car, the owner could be directed to use the two-way communication of the terminal 100 to pay for unpaid time and request that the tire boot is removed.

Clearly, other sensor systems besides cameras 350 can be used to determine when cars are parked in spaces 310 for correlating to payments made at terminal 100.

In addition to being used for operating networked electronic parking meters 100 for vehicles, said networked electronic parking meters 100 may also be used for parking boats, ships and small planes, for example.

The parking meter terminal system of the invention permit an operator of lots 300a, 300b using the system to selectively vend time for a chosen parking space or bay, while providing customer assistance and avoiding fraud by customers who do not pay or do not pay enough.

The system eliminates the need for an attendant to regularly check the lot, since it can be monitored remotely. Terminal 100 maintenance and servicing, such as for repair of malfunctions, and coin and bill collection, can all be prompted by a signal (or lack thereof) received at the central station 200 from the terminal computer 450 through connection 240.

While a specific embodiment of the invention has been shown and described in detail to illustrate the application of the principles of the invention, it will be understood that the invention may be embodied otherwise without departing from such principles.

What is claimed is:

1. A parking meter terminal system comprising:
at least one parking lot having a plurality of uniquely identifiable spaces for parking a vehicle;
a central administration station;
a parking meter terminal in each at least one parking lot, the parking meter terminal comprising:
means for identifying each of the uniquely identifiable spaces in the parking lot;
means for receiving and validating payment for time for a selected one of the uniquely identifiable spaces;
communications means for transmitting and receiving audio and video signals between the parking meter terminal and the central administration station; and
data means for transmitting and receiving data between the parking meter terminal and the central administration station.

2. A system according to claim 1, wherein the communications means transmits and receives audio and video signals across a computer network;

3. A system according to claim 1, wherein the communications means comprises a video display, a camera, a microphone and a speaker connected to a computer in the parking meter terminal, the computer having network means for connecting to the central administration station to transmit and receive the audio and video signals.

4. A system according to claim 3, wherein the video display comprises an LCD panel.

5. A system according to claim 4, wherein the means for identifying comprises a touch screen panel positioned over the LCD panel and means for displaying choices and information on the LCD panel, the touch screen panel being programmed to correspond to the choices displayed.

6. A system according to claim 5, wherein the LCD panel displays both the received video signal and the choices and information.

7. A system according to claim 4, wherein the LCD panel has an areal luminosity of at least 1000 NITS.

8. A parking meter terminal for a parking lot having a plurality of uniquely identifiable spaces for renting for fixed time periods, the parking meter terminal having a two-way communications connection with a central administrative station, the parking meter terminal comprising:
a housing;
display means in the housing for displaying instructions and choices for selection and a video image transmitted from the central administrative station via the two-way communications connection;
audio communication means in the housing for transmitting and receiving audio signals to and from the central administrative station via the two-way communications connection;
selection means on the housing for selecting one of the uniquely identifiable spaces to pay a rent for a fixed time period;
payment means in the housing for receiving and validating payment of the rent for the selected one of the uniquely identifiable spaces;
means in the housing for transmitting and receiving a video signal from the central administrative station via the two-way communications connection; and
means on the housing for initiating communications with the central administrative station.

9. A parking meter terminal according to claim 8, wherein the display means comprises an LCD panel.

10. A parking meter terminal according to claim 9, wherein the selection means comprises a transparent touch-sensitive panel overlaid on the LCD panel.

11. A parking meter terminal according to claim 10, wherein the means for initiating communications comprises a selection displayed on the LCD panel selectable with the touch-sensitive panel.

12. A parking meter terminal according to claim 11, wherein the means for transmitting and receiving a video signal comprises a camera connected to a computer, the LCD panel connected to the computer, and the computer having network means for transmitting and receiving audio and video signals via the two-way communications connection.

13. A parking meter terminal according to claim 12, wherein the audio communications means comprises a microphone connected to the computer and a speaker connected to the computer.

14. A parking meter terminal according to claim 9, wherein the LCD panel has an areal luminosity of at least 1000 NITS.
